(19) United States
(12) Patent Application Publication
(10) Pub. No.: US 2005/0264144 A1
(43) Pub. Date: Dec. 1, 2005

(54) Cabinet door support mechanism

(75) Inventors: Steve Verbeek, Aurora (CA); Lee David Fletcher, Toronto (CA); Genadij Makarewicz, Brampton (CA)

Correspondence Address: BERESKIN AND PARR, 40 KING STREET WEST, BOX 401, TORONTO, ON, M5H 3Y2, CA

(73) Assignee: TK Canada Limited, Toronto (CA)

(21) Appl. No.: 10/856,950

(22) Filed: Jun. 1, 2004

(51) Int. Cl. E05D 7/04; A47B 88/00; E05D 15/00

(52) U.S. Cl. 312/323

(57) ABSTRACT

An up-assist/soft close support mechanism for a cabinet door that opens by moving upwardly and then rearwardly to a partly horizontal position above the cabinet. The mechanism includes pairs of unequal length links on opposite end walls of the cabinet. One of those links is designed as a bell crank. A gas cylinder is coupled between one arm of the bell crank and the cabinet end wall, while the second arm of the bell crank is connected to the door. When a user begins to open the door, the gas cylinder exerts a turning movement about the bell crank which assists opening movement of the door. Conversely, when a user begins to close the door, the bell crank turns in the opposite direction and exerts a compressive force on the cylinder, providing a “soft close” function.

### FIELD OF THE INVENTION

This invention relates generally to cabinets primarily, but not exclusively, so-called overhead cabinets intended for use in an office environment. It is, however, to be understood that the invention may be applied to cabinets used in other environments, for example, kitchens or other residential locations.

### BACKGROUND OF THE INVENTION

An overhead cabinet as used in an office typically is supported from a partition or other wall structure at an appropriate height above a work surface. An overhead cabinet may also be incorporated as part of a piece of office furniture, for example, a free-standing wall unit.

Traditionally, the cabinet is provided with doors that are hinged to the cabinet about a vertical inner edge of the door so that the door swings outwardly to give access to the interior of the cabinet. While this type of door is perfectly functional and acceptable in many situations, it is desirable to provide a door that opens upwardly so as to avoid obstructing space laterally of the door. Mechanisms are available for supporting upwardly opening doors. However, in general, these mechanisms simply comprise parallelogram linkages at opposite sides of the door that constrain the door to move up and down while remaining upright. In other words, the door is in a vertical plane in its normal closed position and remains parallel to that plane as it moves up to the open position. Typically, springs are used to hold the door open.

Again, this type of door support mechanism is satisfactory from a functional standpoint. However, it is necessary to provide for space above the cabinet to accommodate the door in its open position. Also, the door may look somewhat unsightly in the open position, for example, if it protrudes above an office partition.

### SUMMARY OF THE INVENTION

An object of the present invention is to provide an improved door support mechanism which addresses some of these issues.

According to the invention there is provided a door support mechanism for a cabinet having an open front, respective end walls at opposite sides of the front and a door for closing the open front. The mechanism supports the door for movement between a closed position in which the door adopts a generally upright orientation and extends across the open front of the cabinet, and an elevated open position in which the door adopts an at least partly horizontal orientation above the cabinet. The mechanism includes, on each end wall of the cabinet, a pair of unequal length links each having a first end pivotally coupled to the relevant end wall of the cabinet at a first pivot point and a second end pivotally coupled to the door at a second pivot point. The unequal length links are configured and arranged to support the door for movement between said open and closed positions. On at least one of the cabinet end walls is a device comprising a cylinder and a ram which biased outwardly of the cylinder. The device is pivotally coupled at one end to the relevant cabinet end wall and at the other to one link of the relevant pair of links at a third pivot point. The said one link comprises a bell crank pivoted about said first pivot point with said second and third pivot points defining respective arms of the bell crank. The cylinder and ram device acts on the bell crank link in a direction to assist movement of the door upwardly from the closed position and is itself acted upon by said link as the door returns towards its closed position, cushioning closing movement of the door.

In summary, the invention provides a cabinet door that moves up and over the cabinet when the door is opened. The user lifts the door from the closed position and the cylinder and ram device provides an assist force in effect reducing the effort that otherwise would be required to open the door. Conversely, when the door is to be closed, the user initiates movement of the door away from the open position and the closing movement is cushioned by the cylinder and ram device, providing a “soft close”.

The two pairs of linkages (on the respective end walls of the cabinet) preferably are mechanically coupled together. This allows a cylinder and ram device to be used at one end of the cabinet only at least for short (narrow) cabinets. Preferably, cylinder and ram devices are provided at both ends of the cabinet in the interest of balanced opening and closing of the door.

In one embodiment, each pair of links includes a longer link that is pivoted at its first end generally in the center of the relevant end wall and at its second end to the door, adjacent its lower edge. The second, shorter link comprises the bell crank of the mechanism and is pivotally coupled at its first end to the end wall of the cabinet adjacent the top edge of that wall, and at its second end to an upper region of the door. The cylinder and ram device is coupled to this upper link and the two upper links are coupled together by a common shaft that runs horizontally from end-to-end of the cabinet.

### BRIEF DESCRIPTION OF THE DRAWINGS

In order that the invention may be more clearly understood, reference will now be made to the accompanying drawings which illustrate a particular preferred embodiment of the invention, and in which:

FIG. 1 is a three-quarter perspective view from the front and one end of a cabinet provided with a door support mechanism in accordance with the invention, the door being shown in a partially open position;

FIGS. 2 to 5 are end elevational views from the left in FIG. 1 showing the sequence of movement of the door from the closed position (FIG. 2) to the open position (FIG. 5); and,

FIG. 6 is a detail elevational view showing the upper link of the mechanism in full lines in the fully open position of the door and in ghost outline in a partially closed position.

### DESCRIPTION PREFERRED EMBODIMENT

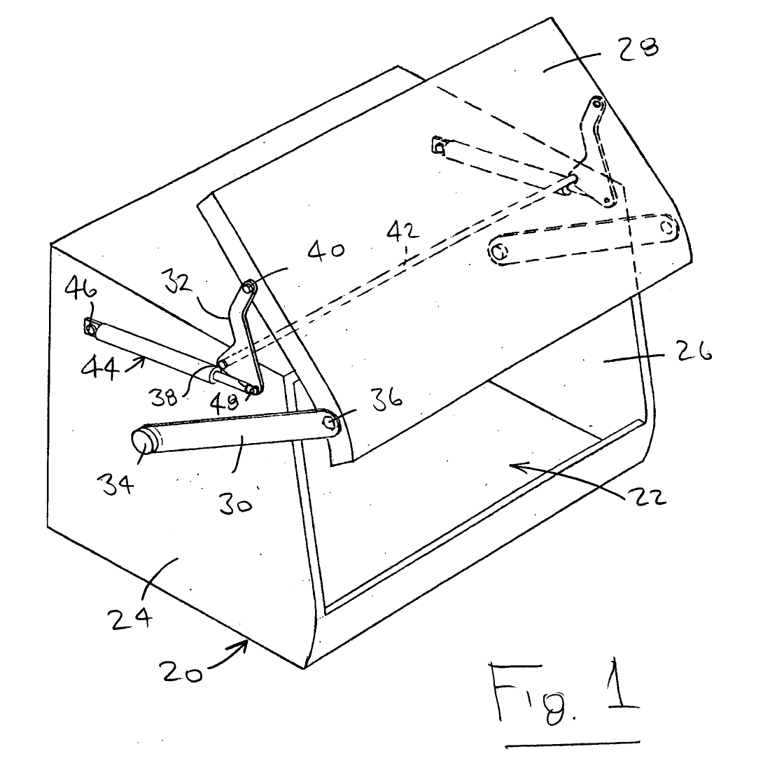

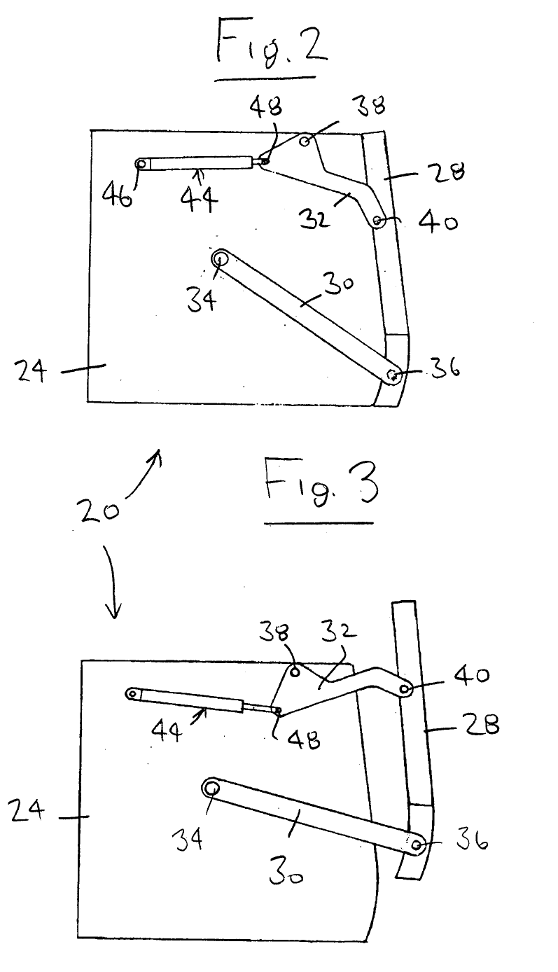

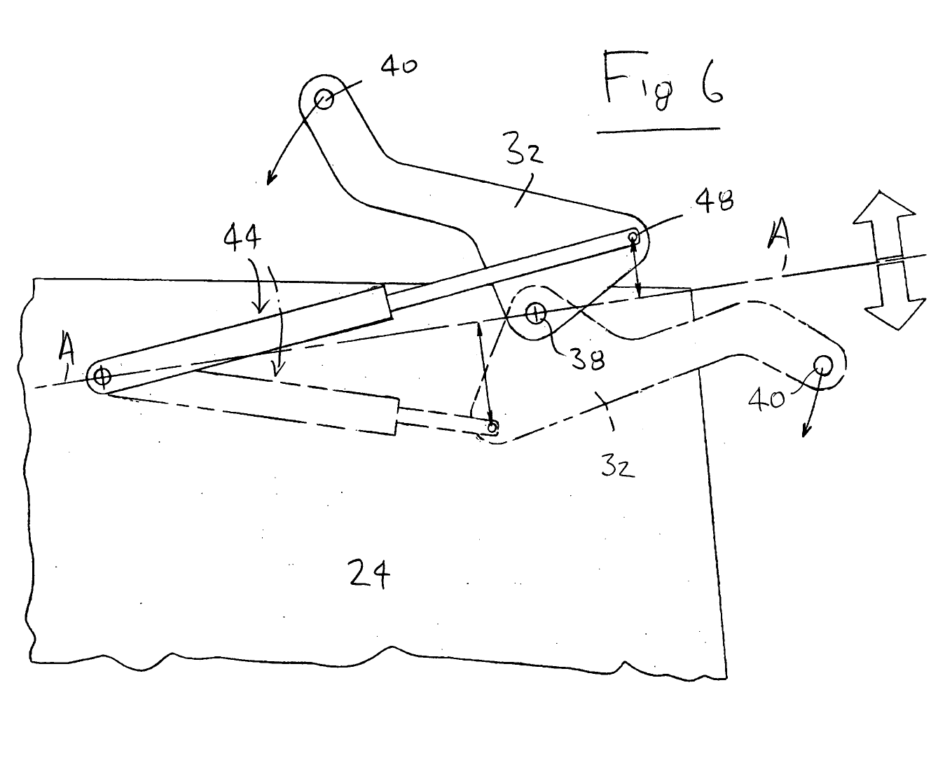

Referring first to FIG. 1, a typical overhead cabinet is generally indicated by reference numeral 20 and has an open front 22 and respective end walls 24, 26 at opposite sides of the open front. A door for closing the open front is shown at 28 in a partially open (or partially closed) position. The cabinet is provided with a mechanism which supports the door 28 for movement between a closed position (FIG. 2) in which the door adopts a generally upright orientation and extends across the open front 22 of the cabinet, and an elevated open position (FIG. 5) in which the door adopts an at least partly horizontal orientation above the cabinet.

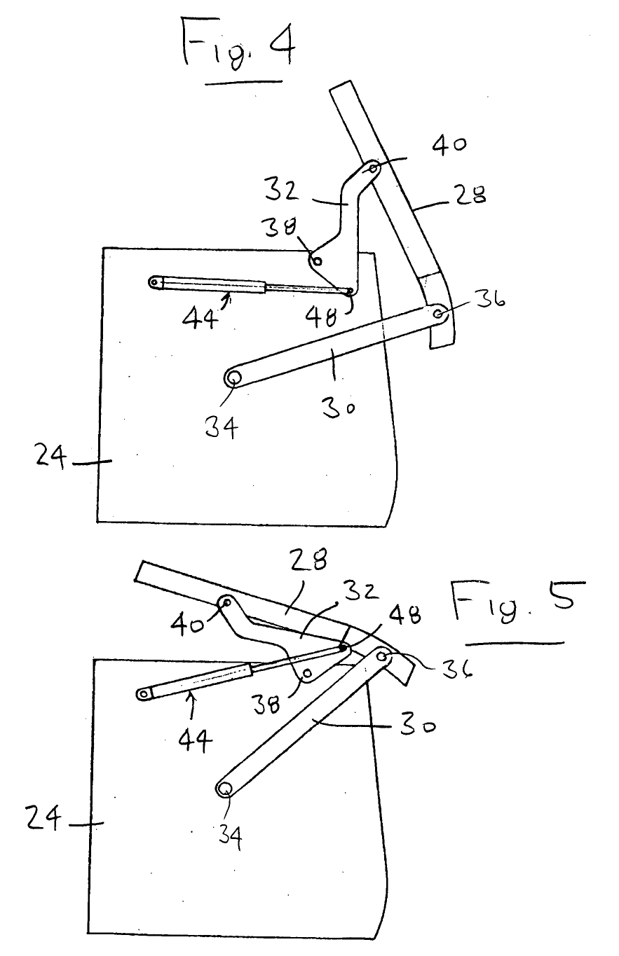

FIGS. 3 and 4 show intermediate positions that the door adopts in sequence as it moves from the closed position of FIG. 2 to the open position of FIG. 5. Of course, the reverse sequence applies when the door is moved to the closed position. In moving from the closed position of FIG. 2, the door travels along a defined path in which it initially moves away from the front of the cabinet (FIG. 3) and then upwardly and angles rearwardly (FIG. 4) before arriving at the elevated open position shown in FIG. 5.

The mechanism includes a pair of unequal length links on each end wall of the cabinet, and a cylinder and ram device (preferably a gas cylinder) that acts on one of the links in each pair. The respective pairs of links are essentially a mirror image of one another and therefore only one pair will be described, namely the pair that is carried by the left-hand end wall 24 as seen in FIG. 1 and in FIGS. 2 to 5.

The two links are denoted 30 and 32 and each link has a first end pivotally coupled to the cabinet end wall at a first pivot point and a second end pivotally coupled to the door at a second pivot point. The first pivot point for link 30 is denoted 34 and the second pivot point 36, while the two corresponding pivot points for link 32 are denoted 38 and 40 respectively.

The longer of the two links (link 30) is pivoted to the end wall 24 generally in a center region of the end wall, while the second pivot point 36 for that link is located adjacent the bottom edge of door 28. In fact, the link is coupled to an end edge of the door.

The first pivot point 38 of the shorter link 32 is located adjacent a top edge of the cabinet end wall and a second pivot point 40 of that link is located in an upper region of the end edge of the door 28. The two shorter links 32 at respectively opposite ends of the cabinet are coupled together by a common pivot shaft 42 (see FIG. 1) which ensures that the two links move in unison.

Associated with the upper link 32 is a gas cylinder and ram device 44 which is pivotally coupled at the cylinder end to the end wall 24 at pivot point 46, and pivotally coupled at its ram end to the upper link 32 at a pivot point 48. The link is configured to form a bell crank that pivots about first pivot point 38, with the door 28 coupled to one arm of the bell crank at 40 and the cylinder and ram device 44 coupled to the other end of the bell crank at 48.

In the door-closed position of FIG. 2, device 44 is exerting a turning moment on link 32 about pivot point 38. However, device 44 is calibrated so that the force that is exerted on link 32 is not sufficient in itself to raise the door. In other words, the door remains closed. However, when a user begins to lift the door, device 44 assists that movement by virtue of the moment that it exerts about pivot 38. Once movement of the door has begun, the movement will continue until the door reaches the fully open position of FIG. 5.

FIG. 6 shows the upper link 32 in full lines in that position. The line denoted A-A extends between the pivot point 46 between device 44 to end wall 24 and the first pivot point 38 for the bell crank link 32. This line represents a “null” or over-center position in that, when device 44 is disposed on line A-A, it cannot exert any turning moment on link 32. In the full line position of link 32 (door fully open), pivot point 48 is slightly above line A-A (distance D) so the linkage has gone “over-center”. The door will then remain in this fully open position until physically moved back towards the closed position. Distance D should be a relatively small positive value so that, while the linkage does go over-center, movement of link 32 does not begin to significantly compress device 44 (since that would inhibit full opening of the door).

To close the door, the user pulls downwardly on the door. Device 44 passes over-center in the opposite direction (i.e. crosses line A-A) and the link 32 then begins to exert a compressive force on the cylinder and ram device 44 represented by the weight of the door and any downward force applied by the user. Device 44 cushions of the closing movement of the door, providing a “soft close” effect.

In summary, the invention provides a so-called “up-assist/soft close” action for the door.

It will of course be appreciated that the preceding description relates to a particular preferred embodiment of the invention only and that modifications are possible with in the broad scope of the invention. Some of those modifications are indicated herein, and other will be apparent to a person skilled in the art. Of course, the particular shapes of the links can vary within the functional constraints of the invention. The cylinder and ram device 44 is preferably a gas-filled device, but mechanical spring devices may be used. Device 44 could act on the lower link 30 rather than the upper link 32. The particular design of the cabinet may of course vary. For example, the cabinet could have a flat vertical or inclined door. It should also be noted that the mechanism provided by the invention is applicable to cabinets of varying lengths. In fact, in embodiments in which there is a connecting shaft as shaft 42 extending from end-to-end of the cabinet, it is possible to apply the invention to cabinets as long as 60″ or more. Conversely, shorter cabinets having a connecting shaft may require a cylinder and ram device (as device 44) at one end only.

In the illustrated embodiment, the pairs of links are shown mounted on the outer faces of the end walls of the cabinet and coupled to end edges of the door itself. The cabinet end walls may be provided with outwardly spaced trim panels to conceal the links and cylinder and ram device. Alternatively, it would be possible to mount the links on the inner faces of the end walls of the cabinet but it would then be necessary to provide appropriate slots or gaps to accommodate movement of the links. Also, the links could be pivotally coupled to the inner face of the door rather than to end edges of the door.

1. A door support mechanism for a cabinet having an open front, respective end walls at opposite sides of the front and a door for closing the open front;
wherein the mechanism supports the door for movement between a closed position in which the door adopts a generally upright orientation and extends across the open front of the cabinet, and an elevated open position in which the door adopts an at least partly horizontal orientation above the cabinet,
the mechanism comprising: on each end wall of the cabinet, a pair of unequal length links each having a first end pivotally coupled to the relevant end wall of the cabinet at a first pivot point and a second end pivotally coupled to the door at a second pivot point, the unequal length links being configured and arranged to support the door for movement between said open and closed positions; and, on at least one of said cabinet end walls, a device comprising a cylinder and a ram which is biased outwardly of the cylinder, said device being pivotally coupled at one end to the relevant said end cabinet wall and at the other to one link of said pair of links at a third pivot point, said one link comprising a bell crank pivoted about said first pivot point with said second and third pivot points defining respective arms of the bell crank, said cylinder and ram device acting on the bell crank link in a direction to assist movement of the door upwardly from said closed position, and being acted upon by said link as the door returns towards its closed position, cushioning closing movement of the door.

2. A door support mechanism as claimed in claim 1, wherein each pair of links includes a longer link pivoted at its said first end generally in the center of the relevant end wall of the cabinet and at its second end to the door adjacent a lower edge of the door, and a second, shorter link comprising said bell crank of the mechanism and pivotally coupled at its first end to the end wall of the cabinet adjacent a top edge of that end wall and at its second end to an upper region of the door.

3. A door support mechanism as claimed in claim 2, wherein the upper links of the respective pairs of links at opposite ends of the cabinet are coupled together by a common shaft that runs horizontally from end-to-end of the cabinet so that the two links pivot in unison.

4. A door support mechanism as claimed in claim 3, wherein both end walls of the cabinet are provided with a said cylinder and ram device each pivotally coupled at one end to the relevant end wall and at the other end to a said link comprising a said bell crank.

5. A door support mechanism as claimed in claim 1, wherein said cylinder and ram device is a gas cylinder.

6. A door support mechanism as claimed in claim 2, wherein the mechanism is configured to support the door in said open position with said third pivot point above an over-center position of said cylinder and ram device with respect to said second link.
